(19) United States
(12) Patent Application Publication
(10) Pub. No.: US 2008/0041276 A1
(43) Pub. Date: Feb. 21, 2008

(54) Method for Re-Using Recycling Asphalts and the Production of Asphalt Aggregate

(76) Inventors: Gerhard Riebesehl, Escheburg (DE); Matthias Nolting, Hamburg (DE); Friedrich Winkelmann, Glinde (DE)

Correspondence Address: LAW OFFICES OF JAMES E. WALTON, PLLC, 1169 N. BURLESON BLVD., SUITE 107-328, BURLESON, TX, 76028, US

(21) Appl. No.: 11/839,422

(22) Filed: Aug. 15, 2007

(30) Foreign Application Priority Data
Aug. 17, 2006 (DE) 10 2006 038 614.0

(51) Int. Cl. C04B 24/36; C04B 24/08

(52) U.S. Cl. 106/660; 106/668; 106/671

(57) ABSTRACT

The method for re-using recycling asphalt should take place in an environmentally friendly manner in conventional plants, it should increase the rate of re-use of recycling asphalts in the manufacture of hot asphalt aggregates and save previously newly used material, such as minerals and binder/bitumen. The degree of hardness of the bitumen in the recycling asphalt, increased by ageing, is set with a plasticiser, for which purpose the combined addition of a hardener is carried out. This plasticiser-hardener system is added to an appropriate mixture with recycling asphalts, primarily in the warm phase of the mixture.

This application claims priority under 35 U.S.C. § 119 to German Patent Application No. DE 10 2006 038 614.0, filed 17 Aug. 2006, titled “Method for Re-Using Recycling Asphalts and the Production of Asphalt Aggregate.”

### BACKGROUND

1. Technical Field

The invention relates to a method for re-using recycling asphalt and the production of new asphalt aggregate, such as warm or hot asphalt aggregate using at least proportions of recycling asphalt to be added.

Within the meaning of the invention recycling asphalts are understood to refer to all products that are obtained, for example, by cutting or crushing bituminous pavings into blocks, which products contain at least re-usable constituents of bitumen and rocks and are processed as granulates for re-use, for example. Such methods for processing recycling asphalt into granulates are disclosed in U.S. Pat. No. 5,626,659 and DE 44 07 822 C2, for example.

What are meant in the invention by asphalts, including warm and hot asphalt aggregates, are all aggregates which contain proportions of bitumen and mineral substances and, if necessary, fillers which are used in preference, for example, as the said asphalt aggregates for application in asphalt highways or other asphalt pavements.

2. State of the Art

Recycling asphalt is gaining increasing significance worldwide using existing resources. In principle almost all recycling asphalts can be re-used, particularly for the manufacture of new asphalt aggregate. Although the re-use requirement, already sanctioned nationally, is now being implemented in the case of the building material asphalt, but certain needs to be improved.

With an annual asphalt production of approx. 60 mill. tonnes in Germany, approx. 15 mill. tonnes of recycling asphalt are currently being re-used in Germany. However, the re-use of recycling asphalt could be much higher.

There are also already clear provisions in the relevant technical regulations and instruction sheets on the quantities of recycling asphalts added to new aggregates which depend on the condition and homogeneity of the recycling asphalts.

Limits are initially set on the quantity added, these limits being dependent on the condition of the recycling asphalts and on the technical possibilities when heating the asphalt granulates (i.e. the processed material finished for feeding into the mixing plant). Since the binders contained in asphalts, such as bitumen, also oxidise and become brittle for long periods lain under traffic (known as ageing), provision has already been made to counteract this ageing by binding suitable fresh bitumen in new aggregate. However, limitations which constitute the addition of a bitumen that is one stage softer are indicated in the technical regulations for the addition of fresh bitumen.

Furthermore, limits are set when heating the asphalt granulates (e.g. in parallel drums). Recycling asphalt is generally heated to up to 130°-140° C., allowing for the atmospheric environmental conditions. Moreover, there may be problems with the degree of purity of the exhaust air on the flue of the mixing plant, whose removal is technically expensive.

If approximately 50% by weight of recycling asphalt were now to be added to the new aggregate, the new mineral substances would have to be heated well over 200° C. Only in this way could the required aggregate temperature of approx. 160-180° C. be achieved. Without the addition of recycling asphalt only 180° C. is required for heating the mineral substances according to the state of the art.

At present three problems currently oppose the higher rate of re-use of recycling asphalts:
1. The degree of oxidation (ageing) of the bitumen in the recycling asphalt.
2. The composition ((currently not every recycling asphalt can be used in every new recipe).
3. New heating technologies would have to be developed to heat the asphalt granulate.

According to the evaluated patent literature the relevant technical world has so far only devoted itself to certain points and only to solving partial problems associated with the re-use of recycling asphalts. These are either environmental or plant and process-specific problems on the one hand, or composition proportions and, in addition, but only in terms of approach, measures for improving the recycling asphalt in terms of individual qualities of its constituents so that the asphalt can be re-used.

This is documented by the following development chronology according to the evaluated patent literature.

A device for processing bituminous aggregate, such as heating recycling asphalt, is therefore proposed in DE G 8907 892.6 U1, but problems relating to the recycling asphalt are not yet examined in further detail.

According to DE 38 31 870 C1 a multi-stage process is proposed for the manufacture of asphalt using granulated recycling asphalt in which granulate and rock are fed into the mixer in a first process stage. The process will ensure the use of a high proportion of recycling asphalt without buffering by pulsating evaporation.

A method for manufacturing asphalt using recycling asphalt is disclosed in DE 41 40 964 A1 for minimising the exhaust gases from the thermal treatment in terms of the hydrocarbon proportion. This recycling asphalt is previously classified into a course and a fine fraction. Only the course portions are initially heat treated and the fine portions are added together with hot bitumen at the end of the heat treatment.

For the economical heating of recycling asphalt in the manufacture of new asphalt, DE 43 20 664 A1 discloses another method for heating this recycling asphalt in a separate drum by flue gases.

Furthermore, EP 0 216 316 A1 also discloses a method for the low-emission processing of a bituminous aggregate with a proportion of granulate as recycling aggregate (recycling asphalt). Here the proportions are first mixed in a mixer, among other things. The proportion having the largest heat content is used by feeding excess heat to the other proportions for temperature equalisation.

EP 0 409 097 A1 explains that cationic emulsifiers and natural or synthetic rubber or synthetic resin dispersions are added to a bitumen emulsion for the environmental recycling of recycling asphalt containing pitch.

DE 195 30 164 A1 also discusses a direction in the development of the construction of asphalt mixing plants for providing asphalts to be processed and referred to in the patent as old asphalts (recycling asphalts) for economical, environmentally friendly and energy-saving processing. A dry drum heated indirectly in the counterflow and divided into regions with different installations and functions was proposed for heating and drying the asphalt granulate, thereby reducing the energy requirement and exhaust gases and preventing cracking of the asphalt granulate containing bitumen.

EP 1 254 925 A1 states, among other things, that old asphalts (recycling asphalts) are red to a mixing plant in which new asphalt is manufactured by a known conventional method. For this purpose paraffin obtained by Fischer-Tropsch synthesis (FT paraffin) is added in defined proportions. The FT paraffin (SASOBIT®) added is intended functionally to increase the resistivity of the asphalt applied as a road surface.

Among other things, the rejuvenation, in the sense of a regeneration of recycling asphalt, is also discussed in DE 0 558 174 A1, the addition of oil obtained from digested sludge in conjunction/mixing with various other chemical components such as nitrogen, oxygen, sulphur, hydrogen and carbon being determined in defined proportions by weight.

Furthermore, according to U.S. Pat. No. 5,755,865, the regeneration of recycling asphalt should be achieved by the use of a shale oil in a defined addition. However, shale oils are environmentally harmful as aromatics, so this method is also disadvantageous.

Also U.S. Pat. No. 5,905,760, U.S. Pat. No. 5,961,709 and U.S. Pat. No. 5,911,815 are concerned with the addition of oils and other additives to conventional asphalt mixtures at low temperatures to modify certain characteristics, such as viscosity and resistibility. The special and hitherto unsolved problems in connection with reusable recycling asphalts are not addressed in these prior patents nor a target of the proposed features.

Furthermore, according to U.S. Pat. No. 6,117,227 asphalt and flux oil are used, but only in the cold process, where flux oil is intended to penetrate and swell the aggregate envelope from old binder expressly in the cold phase in order to guarantee the bond during compression.

On the other hand U.S. Pat. No. 6,159,279 relates to the double enclosing of limited proportions of recycling asphalt in mixtures with a very hard binder.

The circle of different development directions from the state of the art to be considered is closed with US 2004/01/0146351 A1 in which a repair material is proposed which also comprises a binder with recycling asphalt.

An overall view of the analysed state of the art shows that the complex and newly summarised set of problems already discussed, such as:
1. the degree of oxidation (ageing) of the bitumen in the recycling asphalt,
2. the composition (not every recycling asphalt can be used in every new recipe) and
3. the degree of heating of the asphalt granulate limited to 140° C.
   associated with the re-use of recycling asphalts and the manufacture of hot asphalt aggregates has not yet been solved in terms of inner, hitherto concealed relationships.

### BRIEF DESCRIPTION OF THE DRAWINGS

In the drawings:

FIG. 1 shows a flow diagram with plant configuration from obtaining the recycling asphalt and producing the granulate, through testing the granulate in the analysis laboratory and heating the granulate and its weighing, followed by the addition of the combined system of plasticiser and hardener, to mixing of the new asphalt aggregate and its loading, and finally its installation at the construction site,

FIG. 2 shows the examined graphical representation of the development of the Marshall stability and flow value using the system of plasticiser and hardener according to the invention,

FIG. 3 shows the examined graphical representation of the development of density by volume using the system of plasticiser and hardener according to the system, and

FIG. 4 shows the examined graphical representation of the cavity development using the system of plasticiser and hardener according to the invention.

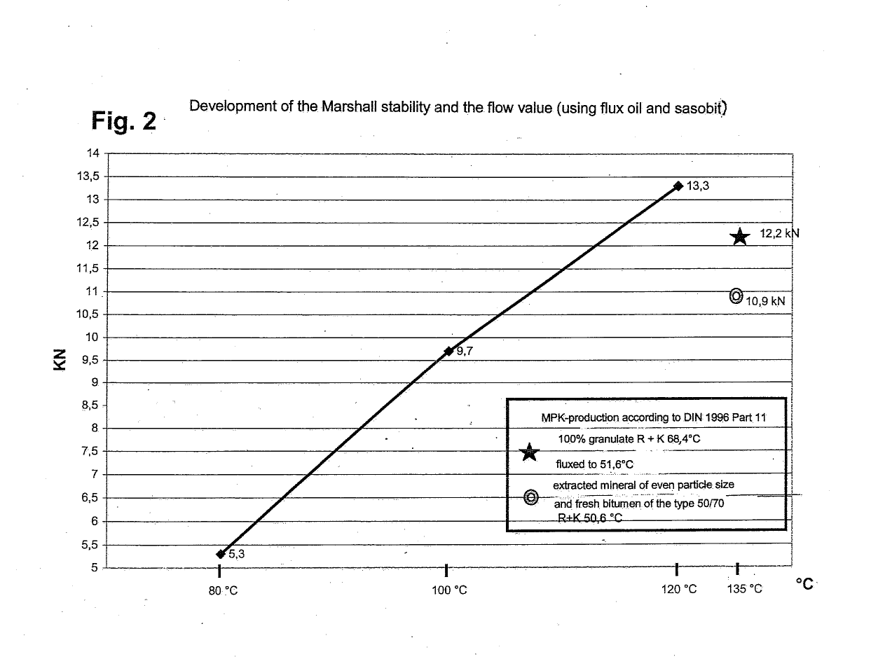

List of reference numbers:

| | |
|---|---|
| 1 = | Obtaining the recycling asphalt by cutting at the site of |
| | extension of an asphalt road |
| 2 = | Screen system for recycled product |
| 3 = | Breaking plant for the production of the granulate |
| 4 = | Examination of the granulate in the analysis laboratory |
| 5 = | Heating the granulate in the drum device |
| 6 = | Weighing the heated granulate |
| 7 = | Addition of hardener |
| 8 = | Addition of plasticiser |
| 9 = | Device for weighing the plasticiser |
| 10 = | Device for weighing the hardener |
| 11 = | Mixing plant for asphalt aggregate |
| 12 = | Loading device, such as silo, for loading the asphalt |
| | aggregate |
| 13 = | Installation of the asphalt aggregate in an asphalt road |
| GT = | Parts by weight |
| M % = | % by weight |
| R + B = | Ring and ball softening point |
| MPK = | Marshall test specimen |
| ★ = | Index for reference value of prior art (in FIGS. 2, 3 and 4) |
| [symbol] = | Index for reference value of prior art (in FIG. 2) |

### DETAILED DESCRIPTION OF THE PREFERRED EMBODIMENT

The approach of the present application in the re-use of recycling asphalts and the manufacture of hot asphalt aggregates, is:
to compensate for the ageing of the bitumen in the recycling asphalt by adding a new regenerating agent,
to create the conditions for ensuring that almost every recycling asphalt can be used in every new recipe of asphalt aggregates in wearing courses, binder courses and/or base courses, and
to maintain the limited degree of heating of the asphalt granulate without additional technical expenditure.

Here the process should take place in an environmentally friendly manner with conventional plants and the rate of re-use of recycling asphalts in the manufacture of hot asphalt aggregates will be increased and material previously re-used, such as minerals and binder/bitumen, saved.

As already mentioned, road pavements or other pavements of asphalt represent high quality building materials which have been quality monitored both internally and externally in terms of their composition and installation. A road to be extended therefore represents a valuable resource whose re-use will always help save raw materials. The following economic and ecological objective must therefore be achieved: the higher the proportion of re-used recycling asphalt can be converted, the higher will be the potential for saving raw materials.

In assessing the proportion of recycling asphalt that can be re-used, the degree of hardening of the bitumen that occurs due to ageing must be carefully considered and evaluated, among other things.

According to the invention the object established is achieved by the provision of a method for the re-use of recycling asphalts and the manufacture of asphalt aggregates by adding substances for reducing the ageing of the bitumen in the recycling asphalt and limiting the degree of heating of the asphalt granulate, characterised by the combined use of a system of a plasticiser and a hardener, which system is added to a suitable mixture with recycling asphalts.

The invention relates first of all to the measure of setting the degree of hardness of the bitumen in the recycling asphalt, increased by ageing, with a plasticiser in order to obtain any desired property of degrees of hardness.

Suitable plasticisers include, for example, flux oils, also obtained from waste oils deriving from the processing of engine or industrial oils from workshops and filling stations. These oils are obtained from crude oils and may therefore be mixed again without problem with bitumen as a residue of petroleum distillation.

Vegetable oils or frit oils could also be used, as could soft bitumen or flux bitumen, which is not otherwise used in asphalt construction.

Essential to the invention is the fact that combined use is made of a system of a plasticiser—as described above—and a hardener—as explained below. This plasticiser-hardener system is added to a suitable mixture with recycling asphalts, primarily in the warm phase of the mixture.

In order to attain the required installation temperature under environmentally friendly conditions, an FT paraffin (SASOBIT® is therefore added as hardener, in the warm phase, for example, to the recycling asphalt (granulate or product to be milled), combined with the flux oil, for example, as plasticiser.

The installations that would otherwise be required when using recycling asphalts may therefore be surprisingly reduced from the beginning by at least 30° C., i.e. from 170° C., for example, to the 140° C. to be maintained or limited during the heating of recycling asphalts. From the start, therefore, a higher temperature is not at all required when producing the mixture. Moreover, use is made of the effect whereby asphaltenes and chemical products in the bitumen, which are also formed during the ageing of bitumen in the asphalt, react extremely well with the FT paraffin (SASOBIT®).

The substances specified here for the plasticiser-hardener system may consist of high boiling substances or substance preparations that are liquid at room temperature, can be mixed with bitumen and have a flash point (COC) of over 120° C., as plasticisers, and a material that is not flowable in the useful temperature range of asphalt, is elastic and resistant to brittle, can be used as hardener.

In a further material form of the plasticisers, higher boiling petroleum fractions, such as lubricant base oils, by-products of lubricating oil manufacture, liquid products produced in the processing of waste oils, native products such as fats and oils or chemically modified fats or oils of vegetable or animal origin, such as fatty acid methyl ester or even mixtures of such substances, may be used.

In a material form of the hardeners synthetically produced paraffin waxes or waxes separated from petroleum, fossil waxes which are obtained from coals, recent waxes of vegetable or animal origin, high-melting fats and products manufactured from them by chemical modification with a wax-like character, such as esters and amides, synthetically produced esters and amides with wax-like properties, thermoplastic polymers with a low mean molecular mass, such as polyolefins, particularly polyethylenes, polyethylene copolymers such as ethylene-vinyl acetate copolymers and ethylene-propylene copolymers, phenol-formaldehyde resins, aliphatic, aromatic and mixed hydrocarbon resins such as styrol-indene resins, recent resins such as collophonium resins and their chemically modified variants such as glycerol and pentaerythrol esters, may be used as the hardener.

A functionally combined multiple effect, in the sense of a combined effect, is therefore achieved: A plasticiser is obtained with the oil components and a hardener is obtained with the FT paraffin (SASOBIT®), for example. This therefore creates the conditions for being able to set the desired property of the asphalts by suitable dosing of the components plasticiser and hardener interacting as a system. Surprisingly it is also possible to use exclusively recycling asphalt without new mineral substances and/or new binder/bitumen. The additives that are obviously necessary, such as other additives, are excluded from this.

The asphalts that are manufactured thus by re-using recycling asphalts, such as asphalt aggregates, can generally be better compressed and are much more resistant to traffic loads, due to the combined action of the said components.

The recently combined system of plasticiser and hardener, therefore consisting of components with intrinsically different actions but supporting each other in their action and combining in the aggregate to produce a uniform effect that achieves the predetermined object in a complex manner, allows the use of at least higher proportions of recycling asphalt up to the maximum amount of recycling asphalt only, compared to methods of prior art. The manufacture of new asphalt aggregate can therefore be carried with lower degrees of heating and with improved technical properties for the applied asphalt layers, such as on asphalt roads or other asphalt pavements.

It has been found, in various test series, that the first component, the plasticiser, acts as a means of refreshing the bitumen contained in the recycling asphalt in the sense of reducing ageing, and replaces lost maltene proportions due to evaporation and chemical ageing. The low temperature behaviour of the bitumen, impaired by ageing, is improved by these components and the embrittlement caused by ageing is reduced.

The said first component may therefore generally—as disclosed above—consist of substances or substance preparations which are liquid at room temperature, are high boiling and miscible with bitumen, and have a flash point (COC) of over 120° C. Already known as flux oil, higher boiling petroleum fractions, e.g. lubricant base oils, by-products of lubricating oil manufactures, liquid products produced in the processing of waste oils, but also native products such as fats or oils or chemically modified fats and oils of vegetable or animal origin, e.g. fatty acid methyl esters, may be used. Mixtures of such substances may also be used.

The second component of the combined system, the hardener, is a means which firstly improves the processing of the recycling asphalt in the asphalt mixing plant by reducing the viscosity of the asphalt mixture, and secondly increases the rigidity and deformation stability of the asphalt courses produced. As already stated, this second component is therefore an elastic and resistant to brittle material that is not flowable in the useful temperature range of asphalt.

In the temperature range of the manufacture and processing of asphalt this component is present in the liquid state, is readily miscible with bitumen and has a viscosity which is lower than or at least as high as the viscosity of typical bituminous binders at the same temperature. As already mentioned, synthetically manufactured paraffin waxes or paraffin waxes separated from petroleum, fossil waxes which are obtained from coals, for example, recent waxes of vegetable or animal origin, high-melting fats and products manufactured from them by chemical modification of a wax-like character, e.g. esters and amides, synthetically manufactured esters and amides with wax-like properties, thermoplastic polymers with a low mean molecular mass, such as polyolefins, particularly polyethylenes, polyethylene copolymers such as ethylene-vinyl acetate copolymers and ethylene-propylene copolymers, phenol-formaldehyde resins, aliphatic, aromatic and mixed hydrocarbon resins such as styrol-indene resins, recent resins such as collophonium resins and their chemically modified variants such as glycerol and pentaerythrol esters, may be used as the second component in addition to FT paraffin (SASOBIT®).

In addition to softer types of bitumen, flux bitumen will also be used, depending on the degree of hardening, which is generally determined by the ring and ball (R+B) softening point and also by the penetration. This is achieved much more easily with flux oils in order to reverse the degree of hardness that occurs.

The knowledge that waste oils deriving from the motor sector, which generally have flash points >200° C. and frequently contain a not inconsiderable proportion of synthetic components, are particularly suitable is exhausted. Such synthetic oils are also obtained in the Fischer Tropsch synthesis. Here sufficient oil will be added to all the binder in the recycling asphalt used to ensure that the R+B softening point of the required fresh binder is obtained. The following relation will therefore apply:
1 GT (part by weight) of flux oil, related to the total binder proportion, reduces the R+B softening point of the resultant binder by 1° C.

The following was calculated as an example:
M % recycling asphalt with a binder proportion of 4.8 M % with an R+B of 62° will be set to an R+B of 52° C., resulting in 62° C.-52° C.=10° C. reducing potential:=10 GR of flux oil;
10 GR of flux oil of 4.8 M % bitumen=0.48% flux oil
   For example, 48 kg of aged bitumen are contained in 1,000 kg of recycling asphalt with a binder proportion of 4.8 M %. 10 GT of 48 kg is equal to 4.8 kg of flux oil. Without further additives 1,004.8 kg of reactivable aggregate would be obtained.

Parallel drums have so far proved satisfactory as devices for heating the recycled cut product or asphalt granulate. With these drums the recycling asphalts are sparingly heated and are heated to approx. 135° C. with limitation of emissions. The quantities added are generally limited to 80 M % because the new aggregate is mixed with the fresh mineral substances heated to a higher temperature, which are also limited, and installation temperatures of >165° C. can be achieved. The building materials could only be installed and compressed property at these temperatures.

These high temperatures are now not required at all, according to the invention until, combined with the plasticiser, flux oil, for example, and a Fischer Tropsch wax or similar substance such as SASOBIT®, are added as hardener.

The installation temperatures can then be reduced by >30° C.

On the one hand use has been made of the fact, according to the invention, that fluxed bitumen types have an improved compression behaviour during installation in asphalts manufactured with them. On the other hand the combined effect is achieved according to the invention whereby both substances (flux oil and SASOBIT) can complement each other in their effect as a system of plasticiser and hardener. Almost any desired degree of hardness of the asphalt can be reliably set by the “plasticiser and hardener” system. Here too the material addition of 3% of the total binder is generally required to maintain the effect of the plasticiser on the one hand and the supporting effect of the hardener on the other.

The advantages of the invention are therefore demonstrated in that:
the resource recycling asphalt is becomes fully usable,
regional recipes can be regenerated and are generally re-usable,
the movement of bulk goods is reduced,
considerable savings to the national economy become possible with almost 100% re-use of the recycling asphalts, and
mixing units can be designed more simply.

According to advantageous method steps:

(1) the system of plasticiser and hardener is added to the mixture in the warm phase;

(2) the appropriate mixing is carried out with recycling asphalts without the addition of new minerals and/or new binder/bitumen;

(3) high-boiling substances or substance preparations, which are liquid at room temperature and can be mixed with bitumen and which have a flash point (COC) of over 120° C., are used as softeners, and an elastic and resistant to brittle material that is not flowable in the useful temperature range of asphalt is used as hardener;

(4) high-boiling petroleum fractions, such as lubricant base oils, by-products of lubricating oil manufacture, liquid products produced in the processing of waste oils, native products such as fats and oils or chemically modified fats or oils of vegetable or animal origin, such as fatty acid methyl esters or also mixtures of such substances, are used as plasticizers;

(5) synthetically produced paraffin waxes or waxes separated from petroleum, fossil waxes which are obtained from coals, recent waxes of vegetable or animal origin, high-melting fats and products manufactured from them by chemical modification with a wax-like character, such as esters and amides, synthetically produced esters and amides with wax-like properties, thermoplastic polymers with a low mean molecular mass, such as polyolefins, particularly polyethylenes, polyethylene copolymers such as ethylene-vinyl acetate copolymers and ethylene-propylene copolymers, phenol-formaldehyde resins, aliphatic, aromatic and mixed hydrocarbon resins such as styrol-indene resins, recent resins such as collophonium resins and their chemically modified variants such as glycerol and pentaerythrol esters, may be used as the hardener;

(6) a flux oil such as a waste oil from the processing of motor or industrial oils from workshops and filling stations is used as the plasticizer;

(7) an FT paraffin (SASOBIT®) is used as the hardener;

(8) the mixing temperature and installation temperature of the asphalt aggregates is >60° C.;

(9) to every 1000 kg of granulate recycling asphalt, which contains aged binder/bitumen at a determined binder/bitumen proportion of 4.8 M %=48 kg:

a) is added approx. 48 kg as a softener, such as flux oil, and

b) is added approx. 1.6 kg as a hardener such as FT paraffin (generally 3% of the binder/bitumen proportion plus a plasticiser such as flux oil);

(10) the asphalt aggregate manufactured:

a) has a Marshall stability and a flow value according to the graph shown in FIG. 2, a value of 13.3 KN being reached after heating to only 120° C., which value is far higher than the stability value of 12.2 KN for a conventional standard aggregate with recycling asphalt, using only one plasticiser, or far higher than the stability value of 10.9 KN for an aggregate with recycling asphalt in which the minerals have been extracted and mixed with fresh bitumen,

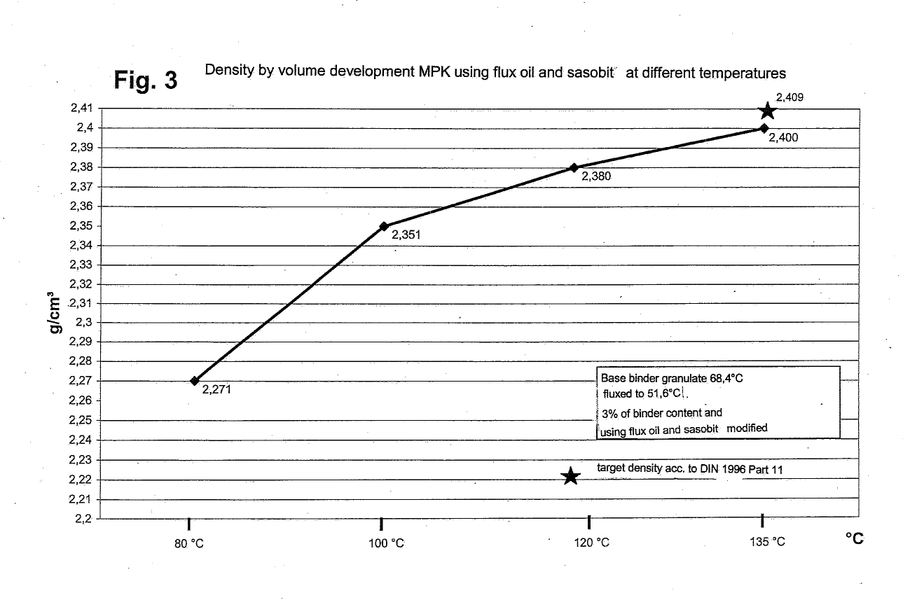

b) has a density by volume according to the graph shown in FIG. 3, a value of 2.4 g/cm³ being reached on heating to 135° C., comparable to the corresponding standard value of 2.409 g/cm³, and/or

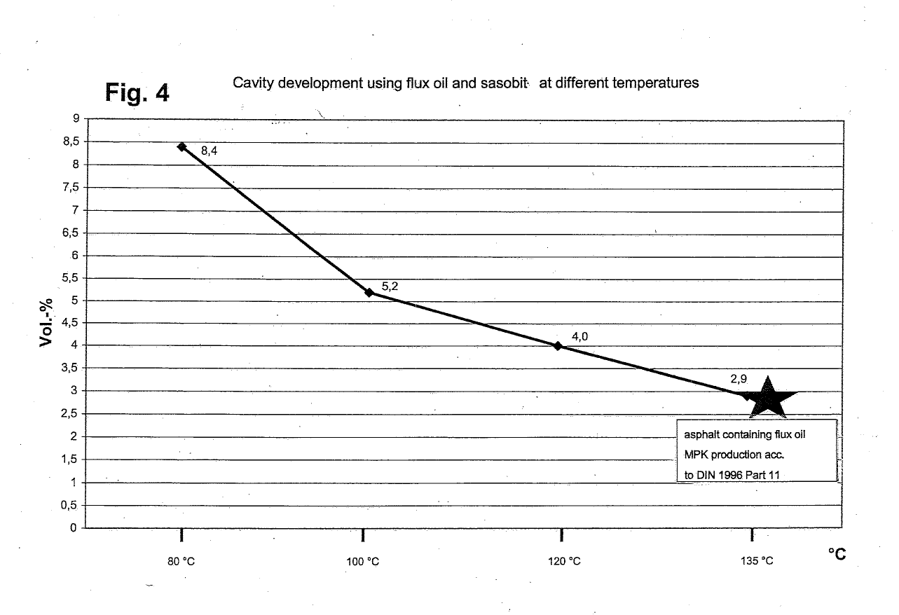

c) has a cavity reduction according to the graph shown in FIG. 4, a value of 2.% by vol., comparable to the conventional standard value, being reached on heating to 135° C.;

(11) the plasticiser is added to the processed asphalt granulate before heating;

(12) the hardener is added to the processed old asphalt granulate before heating;

(13) the hardener is added to the asphalt granulate in the form of fibrous fillers absorbing the hardener;

(14) the hardener is added in the form of compressed pellets which contain the fibrous fillers and hardener;

(15) the use of a plant configuration for the asphalt aggregate to be manufactured has:

a) a device such as a cutter for obtaining the recycling asphalt,

b) a screen system for screening off the required grain sizes from the recycling asphalt,

c) a drum device for heating the recycling asphalt,

d) a mixer for mixing the asphalt aggregate, and

e) a loading device for loading the asphalt aggregate; and

(16) the use of a plant configuration which may have a breaking plant associated with the screen system;

(17) a device such as an analysis laboratory; and

(18) a device for weighing the plasticiser and/or hardener.

The invention therefore solves the problems previously and the technical object established outlined surprisingly easily. The invention is described hereafter in an exemplary embodiment with reference to drawings.

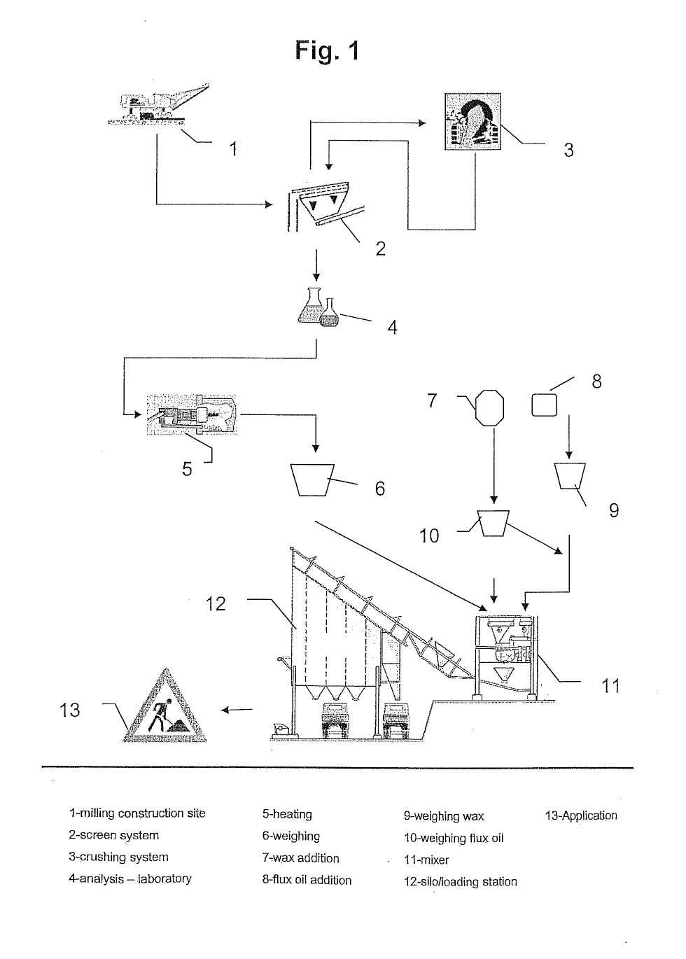

According to FIG. 1 a plant configuration is represented as a schematised flow diagram, comprising:
denoted by 1, the obtaining of the recycling asphalt by means of cutting at the point of extension of an asphalt road to be extended,
a screen system 2, to which the cut recycling asphalt is fed to screen the required grain sizes of the granulate,
a crushing system 3 associated with screen system 2, in which oversizes of the recycling asphalt and/or over-grain sizes are reduced to a usable piece size, then fed to the screen system for screening,
an analysis laboratory 4 for examining the properties, such as total binder proportion (bitumen) and the degree of hardness of its granulate, setting values for the additions of the plasticiser-hardener system and/or determination and/or control of the technological theoretical/actual values, if necessary using a computer aided program which provides the functions of recording, checking and if necessary correcting the technological parameters from the recycling asphalt obtained and/or processed, an analysis of the processed granulate for setting the individual technological parameters and/or checking the actual values obtained,
a drum device 5, e.g. also arranged as so-called parallel drums, for heating the processed granulate, with subsequent weighing, denoted by 6, of the heated granulate,
a mixing plant 11 for manufacturing the asphalt aggregate to be installed, in which
   the heated and weighed granulate and
   the plasticiser-hardener system 7, 8, after its weighing, denoted by 9, 10 are mixed according to the predetermined technological values,
a subordinate loading device 12, such as a silo, for loading the asphalt aggregate and installing the same on a construction site.

In designing and further developing the technological implementation of the invention, it is conceivable for the technological process to be carried out according to items 1 to 13 of the flow diagram in FIG. 1 in a matched logistic chain that takes into consideration the process stages of:
a) obtaining and/or processing the recycling asphalt as a granulate for re-use,
b) analysis of the processed granulate to determine the technological theoretical parameters for heating, weighing, additions of the plasticiser-hardener system and/or the mixture constituents of the asphalt aggregate to be manufactured, and/or
c) if necessary, checking of the actual values of the manufactured asphalt aggregate obtained.

A computer-aided program may be used which has the functions of recording the technological parameters, their checking and, if necessary, correction according to the above process stages a), b) and/or c).

Moreover, the concept of replacing an asphalt road or other asphalt pavement to be extended by the newly to be installed asphalt aggregate, according to the said logistic chain whilst maintaining the existing line or local position, offset in time only by the required technological process of manufacturing the new asphalt aggregate, may also be implemented to the optimum degree.

The core concept of the invention, the combined use of a system of a plasticiser and a hardener, which is added to the corresponding mixture with recycling asphalts, can be implemented to the optimum degree, i.e. without new devices, by means of this plant configuration consisting of conventional individual devices.

In principle FIG. 1 shows the addition of the system of plasticiser and hardener in the warm phase. The said system can be added to the mixture to be produced even before heating (e.g. after the analysis of the granulate in the analysis laboratory 4).

Under corresponding conditions of the recycling asphalt and after a detailed analysis of its constituents it is possible to manufacture the new asphalt mixture without the addition of new minerals.

Specifically and preferably, a flux oil is used as the plasticiser, and an FT paraffin SASOBIT® is used as the hardener.

According the representation according to the invention, the following example demonstrates an application of the invention for commercial and/or industrial use within the framework of an examination according to the invention:

The recycling asphalt granulate processed for manufacturing the new asphalt aggregate is set as 100 M % recycling asphalt. It was evaluated with an analysed binder/bitumen proportion of 4.8 M %. This mass, the binder/bitumen proportion, has a softening point according to R+B of 62° C., which is to be set to 52° C. This results in a difference of 10° C. as the so-called reducing potential, which is equivalent to 10 GT of flux oil. 10 GT (parts by weight) of flux oil of 4.8 M % binder/bitumen therefore results in a requirement of 0.48% flux oil.

The relation was assumed that 1 GT of flux oil, related to the total binder/bitumen proportion, reduces the softening point according to R+B of the resultant binder/bitumen by 1° C.

In 1,000 kg of recycling asphalt processed for reuse 48 kg of (aged) binder/bitumen are therefore present in a binder/bitumen proportion of 4.8 M %, which, after calculating 10 GT of 48 kg, gives a requirement of 4.8 kg of flux oil from the mass of 1,000 kg of recycling asphalt.

Accordingly 1,004.8 kg of aggregate would be obtained, which in this case corresponds to full re-use of the recycling asphalt. Assuming that no new minerals have to be added to the aggregate then reactivated, after a suitable qualitative and quantitative analysis of the recycling asphalt, the masses of recycling asphalts may therefore be fully used adding the plasticiser to masses of new asphalt aggregates, whilst saving these new minerals.

This part of plasticiser, with the effect of the reduced softening point of the plasticiser-hardener system according to the invention, is now combined with the part of hardener so that with the FT paraffin, such as SASOBIT®, as hardener, 3%, i.e. in this case 1.44 kg of all the binder/bitumen, is added to the granulate.

The development results obtained using the plasticize-hardener system according to the invention, in terms of

the improved Marshall stability and flow value,

the density by volume corresponding to the standard values and

the reduced cavity, also conforming to the standard values,

are represented in graphs in FIGS. 2 to 4 in the corresponding dimensions and values.

FIG. 2 shows the development line of the Marshall stability and flow value of the new asphalt aggregate manufactured from the granulated recycling asphalt with the plasticiser-hardener system according to the invention.

Marshall test specimens (MPK) to DIN 1996, Part 11 served as the object of detection. The following were taken as a basis as reference mixtures of prior art:
1. 100% granulated recycling asphalt was processed with an established softening point of the binder/bitumen proportion, according to R+B, of 68.4° C., fluxed to 51.6° C. The stability value is 12.2 KN (denoted by [symbol] at 135° C.
2. Minerals (rocks) extracted from recycling asphalt, i.e. the binder/bitumen proportion was washed out, were processed with fresh bitumen of the type 50/70, the softening point according to R+K being 50.6° C. Here the stability value 10.9 KM (denoted by [symbol] is reached at 135° C.

On the other hand, according to the analysis aggregate manufactured according to the invention shows an even higher stability value of 13.3 KN after heating to only 120° C.

This graph alone demonstrates the advantage of an optimised energy requirement for the heating, thus no additional heating technologies are necessary.

Moreover, the useful value of the aggregate applied as a road surface or other pavement is higher than previous installations.

The invention also demonstrates, according to FIG. 3, that the measured density by volume, at 2.4 with heating to 135° C., is practically equal to the standard value of 2.409 (denoted by [symbol] the latter value being taken as a basis as the target density to DIN 1996, Part 11 and as the reference.

Finally it must also be emphasised that the reduction of the cavity according to FIG. 4, measured according to the invention, corresponds to the value according to DIN 1996, Part 11 (denoted by [symbol] with a value of 2.9% by vol. at 135° C.

It has therefore generally been demonstrated that the invention can not only be used commercially, industrially and economically, but also provides, at least in part, higher useful properties of a newly manufactured asphalt aggregate making full use of the resource recycling asphalt.

What is significant here is that under corresponding conditions of the recycling asphalt and its qualitative and quantitative analysis, mixing temperatures as well as installation temperatures from 60° C. can be achieved.

As for commercial applicability, the invention can be integrated in conventional process flows in an asphalt mixing plant with the re-use of recycling asphalt and in the manufacture of hot asphalt aggregates without new heating technologies having to be used or device extensions being required.

We claim:

1. A method for the re-use of recycling asphalts and the manufacture of asphalt aggregates, the method comprising the steps of:
providing a system of a plasticiser and a hardener; and
adding the system to a suitable mixture with recycling asphalts, so as to reduce the aging of bitumen in the recycling asphalt and limiting the degree of heating of asphalt granulate.

2. The method according to claim 1, wherein the step of adding the system to the mixture is performed in a warm phase.

3. The method according to claim 1, wherein appropriate mixing is carried out with the recycling asphalts without the addition of new minerals, new binder, or new bitumen.

4. The method according to claim 1, further comprising the steps of:
using high-boiling substances or substance preparations, which are liquid at room temperature so as to be mixable with bitumen and which have a flash point (COC) of over 120° C., as softeners; and
using an elastic material, which is not flowable in the useful temperature range of asphalt, as a hardener.

5. The method according to claim 1, wherein the plasticiser is a high-boiling petroleum fraction, such as lubricant base oils, by-products of lubricating oil manufacture, liquid products produced in the processing of waste oils, native products, such as fats and oils or chemically modified fats or oils of vegetable or animal origin, such as fatty acid methyl esters, or mixtures of such substances.

6. The method according to claim 1, wherein the hardener is synthetically produced paraffin waxes or waxes separated from petroleum, fossil waxes, which are obtained from coals, recent waxes of vegetable or animal origin, high-melting fats and products manufactured from the high-melting fats by chemical modification with a wax-like character, such as esters and amides; synthetically produced esters and amides with wax-like properties, thermoplastic polymers with a low mean molecular mass, such as polyolefins, particularly polyethylenes, polyethylene copolymers, such as ethylene-vinyl acetate copolymers and ethylene-propylene copolymers, phenol-formaldehyde resins, aliphatic, aromatic and mixed hydrocarbon resins, such as styrol-indene resins, recent resins such as collophonium resins and their chemically modified variants, such as glycerol and pentaerythrol esters.

7. The method according to claim 1, wherein the plasticiser is a flux oil, such as a waste oil from the processing of oils.

8. The method according to claim 1, wherein the hardener is an FT paraffin.

9. The method according to claim 1, wherein the mixing temperature and installation temperature of the asphalt aggregates is greater than 60° C.

10. The method according to claim 1, further comprising the steps of:
adding approximately 48 kg of flux oil as a softener; and
adding approximately 1.6 kg of FT paraffin as a hardener;
such additions being made to every 1000 kg of granulate recycling asphalt containing aged binder/bitumen at a determined binder/bitumen proportion of 4.8 M % which equals 48 kg.

11. The method according to claim 1, wherein the asphalt aggregate has at least one of a Marshall stability and a flow value of about 13.3 KN at about 120° C., a density by volume of about 2.4 g/cm³ at about 135° C., and a cavity reduction of about 2.9% by volume at about 135° C.

12. The method according to claim 1, wherein the plasticiser is added to the processed asphalt granulate before heating.

13. The method according to claim 1, wherein the hardener is added to the processed old asphalt granulate before heating.

14. The method according to claim 1, wherein the hardener is added to the asphalt granulate in the form of fibrous fillers absorbing the hardener.

15. The method according to claim 1, wherein the hardener is added in the form of compressed pellets which contain the fibrous fillers and hardener.

16. The method according to claim 1, further comprising the steps of:
providing a cutter;
obtaining the recycling asphalt with the cutter;
providing a screen system;
screening off the required grain sizes from the recycling asphalt with the screening system;
providing a drum device;
heating the recycling asphalt with the drum device;
providing a mixer;
mixing the asphalt aggregate with the mixer;
providing a loading device; and
loading the asphalt aggregate with the loading device.

17. The method according to claim 16, further comprising the steps of:
providing a breaking plant; and
operably associating the breaking plant with the screen system.

18. The method according to claim 1, further comprising the step of:
using an analysis laboratory to test the asphalt granulate.

19. The method according to claim 1, further comprising the step of:
providing a weighing device; and
weighing at least one of the plasticiser and the hardener with the weighing device.

20. The method according to claim 1, further comprising at least one of the following steps:
obtaining and/or processing the recycling asphalt as a granulate for re-use;
at least one of analyzing the processed granulate to determine the technological theoretical parameters for heating, weighing, additions of the plasticiser-hardener system, and the mixture constituents of the asphalt aggregate to be manufactured; and
optionally checking the actual values of the manufactured asphalt aggregate obtained.

21. The method according to claim 20, further comprising the steps of:
providing a computer-aided program which has the functions of recording the technological theoretical parameters, checking the technological theoretical parameters, and, optionally correcting the technological theoretical parameters.
